(19) United States
(12) Patent Application Publication
(10) Pub. No.: US 2024/0095598 A1
(43) Pub. Date: Mar. 21, 2024

(54) DATA PROCESSING METHODS AND COMPUTER SYSTEMS FOR WAVELAKES SIGNAL INTELLIGENCE

(71) Applicant: Deep Labs, Inc., San Mateo, CA (US)

(72) Inventor: Patrick FAITH, Pleasanton, CA (US)

(73) Assignee: Deep Labs, Inc., San Mateo, CA (US)

(21) Appl. No.: 18/470,283

(22) Filed: Sep. 19, 2023

Related U.S. Application Data
(60) Provisional application No. 63/408,130, filed on Sep. 20, 2022.

(51) Int. Cl. G06N 20/00

(52) U.S. Cl. CPC G06N 20/00

(57) ABSTRACT

A data processing method includes receiving input data associated with a plurality of transactions; generating, based on the input data, a plurality of wavelets corresponding to the plurality of transactions; storing the plurality of wavelets and corresponding keys associated with the wavelets in a key-value database; and outputting, based on the plurality of wavelets, one or more indicators.

### RELATED APPLICATION(S)

This application claims the benefit of priority to U.S. Provisional Application No. 63/408,130 filed on Sep. 20, 2022, which is incorporated herein by reference in its entirety.

### TECHNICAL FIELD

The present disclosure relates generally to the field of machine learning. More specifically, and without limitation, the present disclosure relates to wavelet-based data processing for machine learning.

### BACKGROUND

Existing methods of transaction fraud detection or risk detection rely on rule-based determinations, decision trees, or artificial neural networks. However, these existing detection methods in financial systems are limited. While machine learning (ML) and artificial intelligence (AI) based systems can be used in various applications such as detecting transaction fraud and are capable of detecting subtle patterns in large data sets, a traditional neural network requires significant computational resources. In cases where millions of transactions occur each day, such as for credit card transaction processing, complex and large neural networks based on historical transaction records introduce latency and slow down transaction processing speed, thus providing a poor user experience.

In addition, in some financial applications, traditional financial indicators do not align well with multi-layer deep neural networks, and the data used for traditional models (e.g., decision trees) do not perform well with machine learning methods. Accordingly, there remains a need for providing indicators and data that can be easily used and/or processed by AI/ML analysis tools in financial systems to enable real-time transaction processing.

### SUMMARY

In accordance with some embodiments, a data processing method is provided. The data processing method includes receiving input data associated with a plurality of transactions; generating, based on the input data, a plurality of wavelets corresponding to the plurality of transactions; storing the plurality of wavelets and corresponding keys associated with the wavelets in a key-value database; and outputting, based on the plurality of wavelets, one or more indicators.

In accordance with some embodiments, a system for processing data is provided. The system for processing data includes: a memory device storing a set of instructions and one or more processors configured to execute the set of instructions to perform operations of the above data processing method.

In accordance with some embodiments, a non-transitory computer-readable storage medium is provided. The non-transitory computer-readable storage medium stores one or more programs. The one or more programs comprise instructions which, when executed by one or more processors of a system, cause the system to perform operations of the above data processing method.

It is to be understood that both the foregoing general description and the following detailed description are exemplary and explanatory only and are not restrictive of the disclosed embodiments, as may be claimed.

### BRIEF DESCRIPTION OF DRAWINGS

FIG. 1 is a diagram of an example server, according to some embodiments of the present disclosure.

FIG. 2 is a flowchart of an example data processing method, according to some embodiments of the present disclosure.

FIG. 3A is an example line of an error log, according to some embodiments of the present disclosure.

FIG. 3B is an example output corresponding to the line of FIG. 3A after a conversion, according to some embodiments of the present disclosure.

FIG. 4 illustrates an example key store, according to some embodiments of the present disclosure.

FIG. 5 illustrates an example representation of historical stock price data with a MACD indicator, according to some embodiments of the present disclosure.

FIG. 6 illustrates an example connection defined in a control file, according to some embodiments of the present disclosure.

FIG. 7 illustrates an example JSON exported wavelet from a wavelake, according to some embodiments of the present disclosure.

FIG. 8 is a diagram illustrating an example general dictionary hierarchy of a control file, according to some embodiments of the present disclosure.

FIGS. 9A-9F illustrate examples of corresponding groups and subgroups of the dictionary hierarchy, according to some embodiments of the present disclosure.

FIG. 10 is a diagram of wavelet construction based on permutations of behaviors, consistent with some embodiments of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to subject matter described herein.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

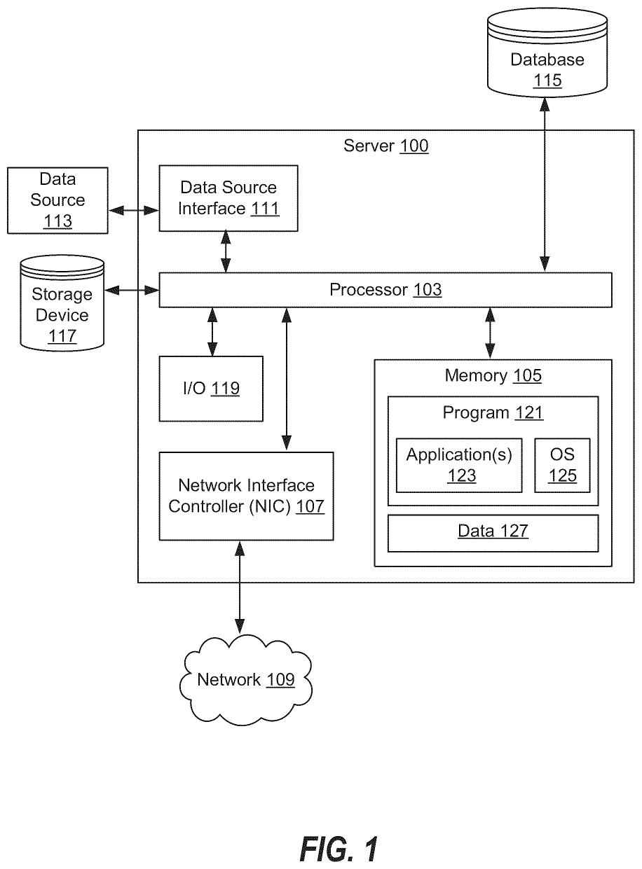

FIG. 1 is a block diagram illustrating an example server 100 for implementing data processing methods and systems, according to some embodiments of the present disclosure. In various embodiments, the server 100 may be a neural network server and reside on a single server farm or may be distributed across a plurality of server farms. As depicted in FIG. 1, the server 100 may include one or more processors (e.g., processor 103), one or more memory devices (e.g., memory 105), and one or more network interface controllers (NIC) (e.g., NIC 107).

In some embodiments, the processor 103 may include a central processing unit (CPU), a graphics processing unit (GPU), or other similar circuitry capable of performing one or more operations on a data stream. The processor 103 may be configured to execute instructions that may, for example, be stored on memory 105. In some embodiments, processor 103 may also include a neural processing unit, field-programmable gate array, or quantum CPU, but the present disclosure is not limited thereto.

The memory 105 may be volatile memory, such as a random-access memory (RAM) or the like, or non-volatile memory, such as flash memory, a hard disk drive, or the like. The memory 105 may store instructions for execution by the processor 103. The NIC 107 may be configured to facilitate communication between the server 100 and other connected systems (not shown) over at least one computing network (e.g., network 109). Communication functions may thus be facilitated through one or more NICs, which may be wireless and/or wired and may include an Ethernet port, radio frequency receivers and transmitters, and/or optical (e.g., infrared) receivers and transmitters. The specific design and implementation of the one or more NICs depend on the computing network 109 over which the server 100 is intended to operate. For example, in some embodiments, the server 100 may include one or more wireless and/or wired NICs designed to operate over a GSM network, a GPRS network, an EDGE network, a cellular network, a Wi-Fi or WiMax network, and a Bluetooth® network. Alternatively or concurrently, the server 100 may include one or more wireless and/or wired NICs designed to operate over a TCP/IP network.

The processor 103, the memory 105, and/or the NIC 107 may be implemented as separate components or may be integrated in one or more integrated circuits. The various components in the server 100 may be coupled by one or more communication buses or signal lines (not shown).

As further depicted in FIG. 1, the server 100 may include a data source interface 111 configured to communicate with one or more data sources 113. For example, the server 100 may communicate with data source 113 or any other server (e.g., an edge server) using a RESTful API or other high speed interface, such as remote procedure call. In some other embodiments, the data source interface 111 may, in whole or in part, be integrated with the NIC 107. The data source 113 may communicate with the server 100 using a software development kit in order to provide data and receive processing results. For example, the data source 113 may include edge nodes or edge servers (e.g., web servers or phone log systems) and databases storing historical transactions and account details, and may also process and/or approve transactions. In some embodiments, the data source 113 may also include an electronic sensor, a database on past sensor data, or a data source accessible via an API. Further, the server 100 may connect directly to other data sources (not shown) via the network 109. For example, the data source 113 may provide communication protocols for the server 100 to use in order to retrieve or receive data from external data providers. In some embodiments, the server 100 may operate as a virtual or cloud server, and may include a plurality of servers that distribute processing via a thread library.

In some embodiments, the server 100 includes a database 115 and/or a storage device 117. In some other embodiments, the server 100 may be operably connected to the database 115 and/or the storage device 117. For example, the database 115 may be a wavelet database or other digital database, which may be stored, in whole or in part, on the server 100 and/or, in whole or in part, on a separate server (e.g., one or more remote cloud storage servers). The storage device 117 may be volatile or non-volatile storage device, such as a RAM, a ROM, a flash memory, a hard disk drive, or the like. In some embodiments, the server 100 also includes a local database, such as data stored in a ROM. An Input/Output (1/O) module 119 of the server 100 may be configured to enable communications between the processor 103 and the memory 105, the database 115, and/or the storage device 117.

As depicted in FIG. 1, the memory 105 may store one or more programs 121. For example, the program(s) 121 may include one or more server applications 123, such as applications that facilitate graphic user interface processing, facilitate communications sessions using the NIC 107, facilitate exchanges with the data source 113, or the like. The programs 121 may include an operating system (OS) 125, such as DARWIN, RTXC, LINUX, iOS, UNIX, OS X, WINDOWS, or an embedded operating system such as VXWorkS. The operating system 125 may include instructions for handling basic system services and for performing hardware dependent tasks. In some implementations, the operating system 125 may include a kernel (e.g., UNIX kernel).

The memory 105 may further store data 127, which may be results computed via one or more programs 121, data received from the NIC 107, data retrieved from the database 115 and/or the storage device 117, or the like.

Each of the above identified instructions and applications may correspond to a set of instructions for performing one or more functions described above. These instructions need not be implemented as separate software programs, procedures, or modules. The memory 105 may include additional or fewer instructions. Furthermore, various functions of the server 100 may be implemented in hardware and/or in software, including in one or more signal processing and/or application specific integrated circuits.

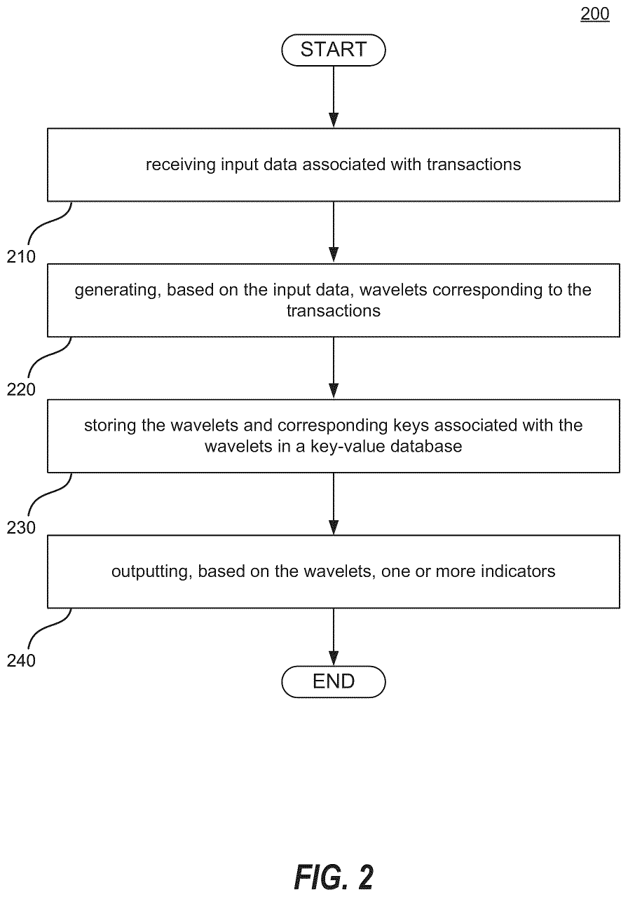

FIG. 2 is a flowchart of an example data processing method 200, according to some embodiments of the present disclosure. In some embodiments, the server 100 of FIG. 1 may execute some or all steps of the data processing method 200 to implement the wavelake processing to generate wavelake files storing wavelets. Steps of the data processing method 200 may also be distributed among a plurality of servers, such as in a cloud configuration. Alternatively stated, the server 100 of FIG. 1 may be a system for processing data, which includes a memory device storing a set of instructions, and one or more processors configured to execute the set of instructions to perform operations of the data processing method 200. For example, the memory 105 may include a non-transitory computer-readable storage medium storing one or more programs 121. The one or more programs comprise instructions which, when executed by one or more processors 103, cause the system to perform operations of the data processing method 200.

In step 210, the server 100 may receive input data. For example, the input data may be associated with multiple transactions. The term “transaction” used in the present disclosure may refer to any data including an indication of an amount of currency or commodity that is transferred between parties. The transaction need not be received in any particular format but may be represented in any appropriate form such as arrays, digital signals, or the like. The transaction may be received from one or more memories (e.g., a volatile memory such as a random access memory (RAM) and/or a non-volatile memory such as a hard disk) and/or across one or more computer networks (e.g., the Internet, a local area network (LAN), or the like). Alternatively, the processor may receive raw data and convert the data into a format representing a transaction. For example, the processor may receive a data with time, location, party identifiers, amount, and the like and may convert this data into a single bundle representing a transaction.

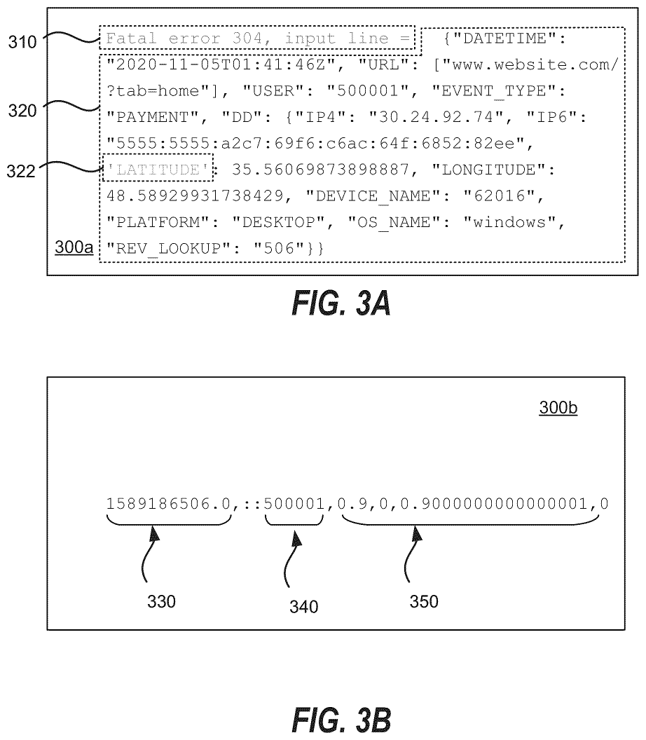

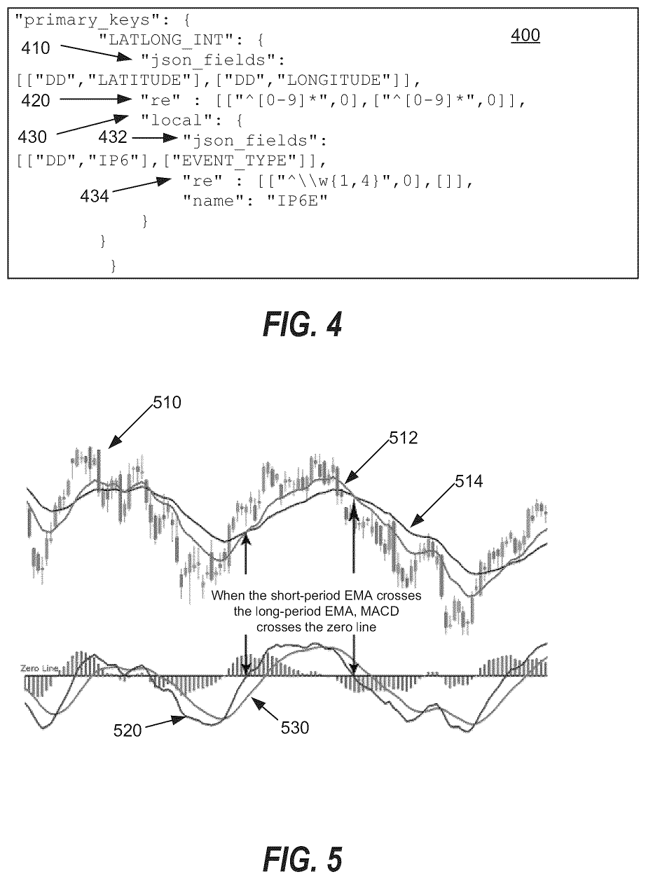

In some embodiments, in step 210, edge logs from one or more edge nodes, external data feeds from an external database, or a combination thereof can be received as the input data. The input data may include unformatted free text, data in JavaScript Object Notation (JSON) format, Corrupted JSON format, Comma-Separated Values (CSV) format, and/or unformatted logs. For example, an example line 300a of an error log is shown in FIG. 3A, which includes an error message 310, a JSON message 320 having a malformed JSON 322. The edge nodes of an enterprise system may include thousands of computing systems saving logs (e.g., firewall, customer support log, etc.). In various installations, there may be thousands of edge logs that are normally not available for central processing.

In step 220, the server 100 may generate, based on the input data, a plurality of wavelets. The wavelets may correspond to the transactions received at step 210. In step 220, the input data (e.g., enterprise's internal logs that are along the edge of the system(s) and external data feeds) are converted to wavelets. As used herein, the term “wavelet” refers to any data that may be represented as a brief oscillation, with an amplitude rising from zero to a maximum and returning to zero over a finite period of time. The wavelet need not be received in the form of an oscillation but may be represented in any appropriate form (e.g., an array, a vector, a matrix, a tensor, a digital signal, or the like). For example, the new transaction may have associated properties (such as time, location, merchant, amount, etc.), and the server 100 may convert the new transaction (along with its associated properties) into a wavelet or into an array or other format that represents a wavelet. Accordingly, edge logs can be converted into wavelet streams.

FIG. 3B is an example output 300b of the line 300a of FIG. 3A after conversion to a wavelet, according to some embodiments of the present disclosure. As shown in FIG. 3B, the output 300b includes a timestamp field 330 (“1589186506.0”), followed by a key field 340 (“500001”) and a floating-point feature vector field 350 (“0.9,0,0.9000000000000001,0”).

For each core financial transaction, there are normally hundreds of leading edge events, which can build up a behavioral profile for the transaction. With a minimal amount of fields taken from the edge logs, a behavioral profile can be obtained. In some embodiments, a configuration file is required to define how edge logs are converted to wavelet streams. The configuration file may be site specific, and the control files for initial stream conversions are created based on planning and data engineering practices.

For example, when a JSON message is converted into a wavelet, a corresponding key may be a string formed from a regular expression (REGEX) based on the JSON values. Regular Expressions (REGEX) are special text string for describing a pattern for performing a method for processing complex data, and are widely used throughout the industry. In wavelet/wavelake processing, REGEX can be used in order to convert any type of CSV or JSON data into a single key or complex key. The wavelet value may have different forms, including a moving sum of count of occurrences (“Primary”), a moving sum of amounts within each occurrence (“Amount”), a moving sum of input amount minus moving amount or count (“Diff(STD)”), a moving sum of the results of a RCNN network segment (“Network”), and/or a moving sum of ratios of related moving averages (“Reference”), based on how wavelets are generated.

For example, in order to create a moving average, a wavelet with a sum of moving amounts is divided by a wavelet of sums of moving counts. When two transactions occur close in time, then the two transactions can be aggregated together in a wavelet placed within the first phase. If events are far apart in time, then those values can be distributed across the entire wavelet as defined by the delta time. The wavelet may take the remainder of any moving sum calculation and move the remainder into a next bucket or phase, and a wavelet can be viewed as a cascade of bucket moving sums, with each phase being the remainder or next bucket.

Accordingly, by converting any type of transaction or event into a wavelet of moving sums, the wavelet may represent the JSON data as a series of floating-point numbers, which allows the data to be operated by any machine learning or AI algorithms, regardless of its transactional form.

In some embodiments, in step 220, one or more first wavelets can be generated from the input data (e.g., transactional data) directly, and one or more second wavelets can be derived from the one or more first wavelets previously obtained. For example, among the five different wavelet generation types above, an input JSON event may be directly converted into a wavelet for the first three types. For all transactions, the first type of wavelet (a moving sum of occurrences) can be created for all primary_keys. Optionally, for a primary key, the second type of wavelet (a moving sum of amounts) can be created if there is an amount related to the key. When a moving difference is needed on the amount, then the third type of wavelet can be generated, which may be close to a moving standard deviation.

In some embodiments, a primary key is not associated with an obvious amount or value for the key, or a more representative value can be generated. For example, when the number of failed login attempts versus the number of total login events is stored as occurrence wavelets, then a ratio of the occurrences can be the value to be used, instead of an actual number found in the transaction. Finally, since the wavelet transforms are vector operations, complex machine learning algorithms can generate any new value, which can be looped back as an amount into a new wavelet.

In step 230, the server 100 may store the plurality of wavelets and corresponding keys associated with the wavelets in a key-value database. In some embodiments, multiple key-value databases storing the wavelets can be merged into a single file or a segmented file. Specifically, the wavelets converted from non-binary logs can be saved in a file type called a “wavelake.” In some embodiments, a wavelake file can be viewed as a lossy compression format. On edge servers (such as web servers or phone log systems), the wavelake files can be copied to Machine Learning Operations (ML-OPS) locations and merged into final wavelake files. For wavelets to be saved in the wavelake files, data sorting may be required. In some embodiments, the merging thousands of wavelake partitions can occur across large time scales.

The wavelake files may be structured for streaming financial transactions and for holding the stream for a key-value pair, where the value is a wavelet. The wavelets inside wavelake files can be optimized specifically for financial transactions and events leading up to a financial transaction.

In some embodiments, the actual wavelake may be a key-value database, or key-value store, during processing, which can be either saved as a large JSON file after the wavelake process finishes, or can also be sent for further processing as a JSONL file. In other words, the key-value database can be stored into a memory in a data serialization format, such as a JSON file. A JSONL wavelake file (e.g., wavelake groups) can be saved per line in JSON, and those JSONL transactions can be merged with actual transaction data feeds to create downstream aggregate wavelake files. In some embodiments, if a Hadoop format output is requested, the JSONL line can be a wavelet key followed by tab, then the JSON data for the wavelet. This allows complex map/reduced processing and can be used when multiple servers and systems may need to compress their logs before deletion and output the compressed logs as wavelets to aggregate systems, and can be applied for logs of web servers, firewalls and physical access.

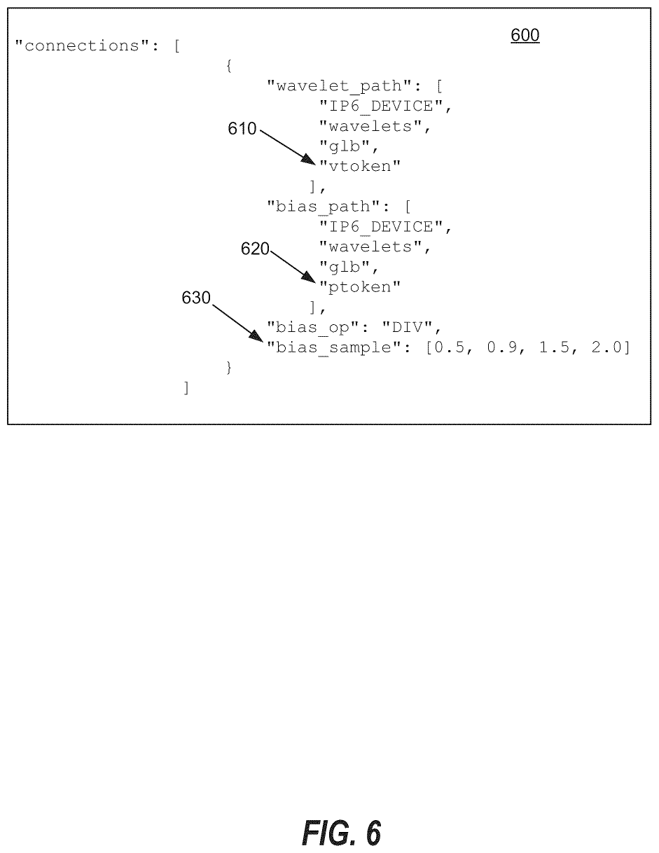

The keys in wavelake files can be made up of multiple JSON fields. For example, a key holding wavelets containing the usage patterns of latitude and longitude is easy to configure in the control file. It is noted that while EMVCo's device specifications used in many industries have shortened JSON tags, the full tag name is used in these examples. FIG. 4 illustrates an example key store 400, according to some embodiments of the present disclosure. In the example of FIG. 4, the integer part of possible geo position (e.g., the GPS coordinates value) of a user device may be used as a key value, and in the tag 410 named “json_fields,” two different fields are referenced. In the regular expression “re” field 420, the integer part of the GPS values are only used to create a corresponding key.

In the embodiments of FIG. 4, within the key store, a local key list is also used. Accordingly, within the key's value object, there is a list of local keys that are also contained. In the present example, the first part of the IP6 address is joined with an event type. In some cases, the event type may be risky events indicating statistical issues, including login failures or password resets. As shown in FIG. 4, a local key can be defined within a primary key using the “local” tag 430 and also requires the “json_fields” tag 432 and the “re” tag 434. In some embodiments, only one local key is allowed per primary key.

In step 240, the server 100 may output, based on the wavelets, one or more indicators. By the above operations, the server 100 may convert an enterprise's internal signal impulses, which are often along the edge of the systems, to provide easily processed indicators. For example, the outputted indicators can be financial indicators used by various methods in financial systems. The one or more indicators can be fed to a deep learning system for real-time processing to implement various applications, such as risk analysis, financial fraud analysis, customer credit analysis, etc.

In some embodiments, wavelets may be a type of tensor. After transactional impulses are converted into wavelets, various calculations can be performed based on linear mathematics using matrix operations. Accordingly, the network may read the key-wavelet pairs from the wavelake files to calculate financial indicators or perform other complex processing, such as running a Region-based Convolutional Neural Network (RCNN).

In addition to the above characteristics and behaviors, wavelake files may offer other beneficial properties. For example, wavelake files can be created without sorting the data by time. Compared to normal exponential smoothing algorithms which require sorting the data by time, the wavelets can be used to process the data out of time order. In some embodiments, this ability may be beneficial where event logs from various data sources may be time-delayed, and may be received out of order, or even after a decision was made.

When a wavelet comes in and the wavelet is associated with a transaction with a timestamp older than the timestamp of the most recent transaction, the wavelet is “aged” and then summed into the current time wavelet. By this approach, a parallel processing can be achieved in systems like Hadoop, and the signal integration can also be achieved on systems having diverse log processing requirements.

In some embodiments, traditional indicators (e.g., a Moving Average Convergence/Divergence (MACD) indicator) can be restructured into a wavelake. By the wavelet-based approach disclosed in various embodiments of the present disclosure, the data used to create an indicator can be increased by a factor between a thousand to a million compared to traditional approaches. Thus, a financial system can be modified to have indicators corresponding to different purchase types, and each user logging into a site may have his or her own personalized indicator as a wavelake, which can be rolled up into aggregate indicators. In some embodiments, other options may be introduced in converting the indicator, by having millions of “floating” keys having their own MACD indicators. Accordingly, the aggregate indicator can be more robust in time.

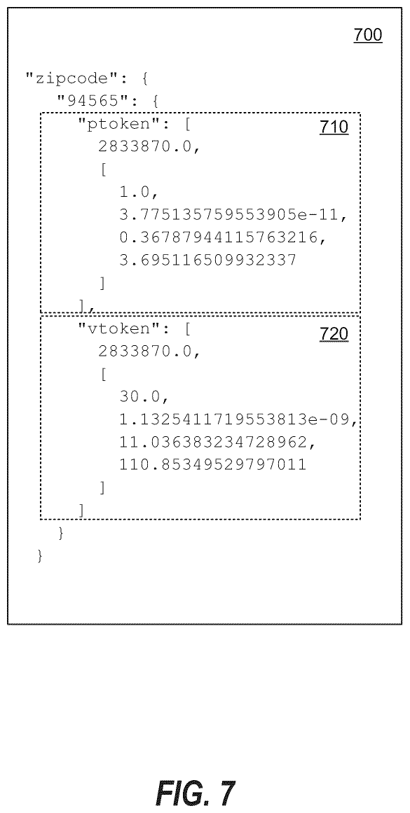

FIG. 5 illustrates an example representation of historical stock price data 510 with a MACD indicator. The MACD series 520 shows the difference between a short-period exponential moving average (EMA) 512, and a longer period EMA 514 of the data series. The average series 530 is an EMA of the MACD series 520 itself. For example, a MACD indicator may be a 12-month moving average subtracted from a 24-month moving average.

An example of the wavelake may be a customer logging in to a financial institution to make a trade. Assuming that there are 1 million customers logging in to make a trade, a MACD calculation can be performed for every event related to that customer as they log in (e.g., for each log change on any system during the entire trade process for that customer). In general, for wavelake processing, a transaction/event can be converted to an impulse which affects a wave or collection of waves. The basic behavior can be shown according to the following equation:

JSON|CSV→{key_{|REGEX|:impulse}→{key:[wavelet]}}

In some embodiments, each row of a JSON (line) or CSV file can be viewed as a transaction and be taken through the wavelake processing. The wavelets can be stored in a RAM key store. In this example, a JSON transaction having a section named “DD” with a subfield named “IP6” is used. For the subfield named “IP6,” the last two sections of the IP6 value are used as a key, according to the following statements in a control file:

“json_fields”:[[“DD”,“IP6”]],

“re”:[[“w{1,4}:w{1,4}w{1,4}:w{1,4}$”,0]].

Further details are to be discussed in later paragraphs.

In some embodiments, the control file may hold the required information for creating and processing data using the wavelake. Phases of a wavelet are required to convert event impulses into corresponding wavelets. In traditional MACD processing, only 12-month or 24-month moving averages are used. On the other hand, the wavelets may comprise a series of exponential coefficients, which allows defining the meta data of control files in seconds. Further details are to be discussed in later paragraphs.

In some embodiments, the control file may include “json_fields” and “phases” tokens, which may be used to create wavelets in the wavelake key value store. For example, the “phases” token may be defined according to the following statements in a control file: “phases”: [3600.0, 86400.0, 2592000.0, 31104000.0]

In the above example, we may consider the two first phases (in seconds), which corresponds to basically the last day of transactions with that IP6 section versus a year. In some embodiments, each phase can be independent. For example, the last 24 hours of transactions associated with the second phase may exclude the most recent hour of transactions associated with the first phase.

In some embodiments, in step 240, the wavelets can be converted into one or more indicators according to a filter matrix, a bias vector, and a weight vector. For example, in order to create a MACD indicator, one connection is required to convert a wavelet into a MACD value, along with a vector configured to convert to a final scalar value. In a general case for a normal neural network, a connection may be merely a scalar weight times an input value. In wavelake processing, a single connection may function as a real neural network and perform a complex convolution filter with recurrence. Accordingly, a wavelet can be converted into a series of moving averages by “dividing” a wavelet with a bias vector. A general formulation per connection can be shown as:

wave_{vector}⊗FilterₘₐₜᵣᵢₓØBias_{vector}⊗Weight_{vector}

By default, if a filter matrix is not defined in the control file, the filter matrix can be defined as an identity matrix. Similarly, if no weight vector is defined in the control file, the weight vector can be a vector having all 1.0 values. The bias vector is used for performing a vector division going through a dirac equation. In some embodiments, converting a wavelet to a series of moving averages can be complicated because it can be difficult to point the connection and the corresponding components in the wavelet.

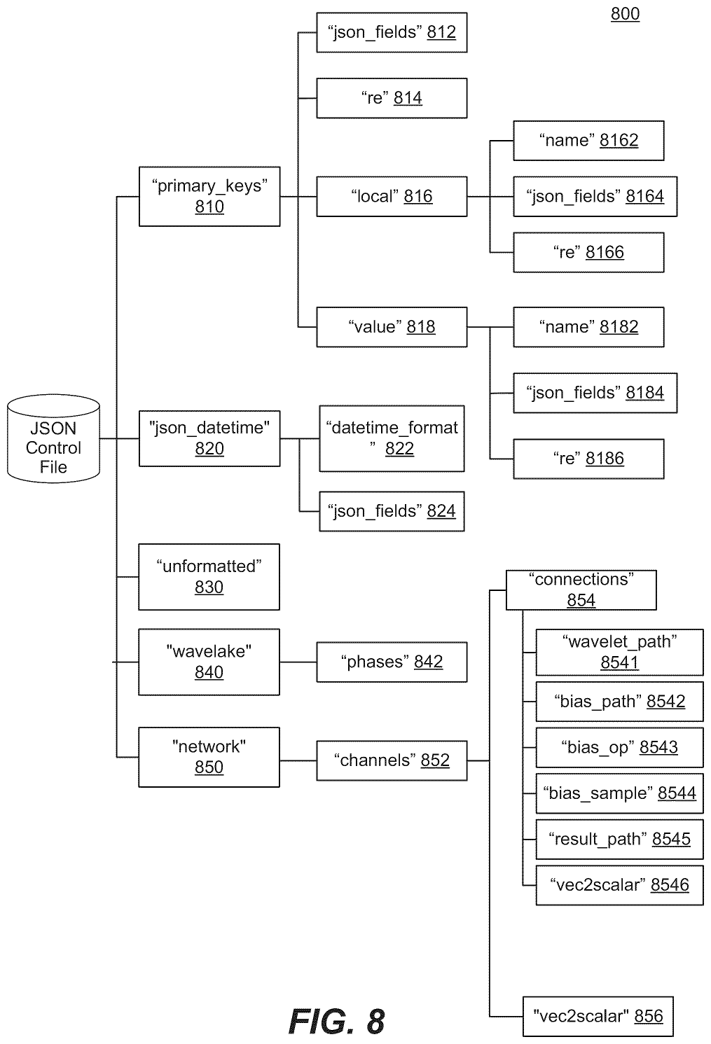

FIG. 6 illustrates an example connection 600 defined in the control file, according to some embodiments of the present disclosure. In the example of FIG. 6, the actual wavelet was stored in the wavelake key store under IP6_DEVICES. The actual last sub key is the component type of the wavelet. The “vtoken” 610 is a value token (e.g., a latency value on the IP6 device through the network) and the “ptoken” 620 is used as a bias, which could be thought of as a moving sum rather than a moving average. Accordingly, in the present example, this results in a series of moving value sums divided by a series of moving total count sums.

The actual “bias_sample” vector 630 can be configured to modify the division, in which for the first phase the moving total sum must be above 0.5, and for the second phase the moving total sum must be above 0.9, and so on. If there weren't enough samples for the division, a zero value can be created for the specific phase. In some embodiments, a final vector multiplier may be configured to convert the obtained phases into a final MACD scalar value. In the present example, the phase associated with the last hour can be weighted higher than the phase associated with the last 24 hours, then subtract that from all the remaining time using the following vector “vec2scalar” in the control file: “vec2scalar”[0.6, 0.4, −0.5, −0.5]. Further details are to be discussed in later paragraphs.

With the foregoing improvements enabled by wavelet processing, shorter or granular windows such as hourly to yearly moving averages can be compared rather than the 12-month or 24-month moving averages used in traditional systems. In various embodiments, any value can be used in the phases down to the second scale. The operations discussed above allow the integration of a diverse set of logs, which may be difficult to be used in real-time decision making in the traditional solutions.

It is noted that the MACD indicator described above is merely an example and not meant to limit the present disclosure. Different indicator types can be carefully engineered by financial analysts creating reusable templates. The regular expressions are set to parse the input data into corresponding keys carefully. The entire series of indicators can be generated per transaction, which can be then fed into enterprise software (e.g., deep learning or expert systems), for final decision making. For the example use case discussed in the above embodiments, if there is a serious problem from a IP6 address, which could have been determined from a mix of firewall logs, call center logs, account management logs and account login logs, a trade could be blocked or sent to investigations for further review in real time.

As discussed above, wavelake files can be used where thousands to millions of transactions are compressed into wavelets saved in key value stores. These key value stores can be configured to export indicators quickly in real-time, for making decision.

Accordingly, by the above operations of the data processing method 200, with the wavelakes, non-linear signal impulses found in enterprise logs and external feeds can be converted into expressions that can be solved with linear algebra used for financial engineering. In some embodiments, signals or data from external feeds can be merged into useful feature vectors in enterprises. Specifically, in the wavelake processing, an enterprise's internal logs that are along the edge of the systems and external data feeds, can be converted to corresponding wavelets.

To this end, wavelets have various useful properties for stream processing. First, there is no need to sort historical files before processing. Second, the wavelake files can be merged from multiple data sources across multiple time domains. Third, the wavelets allow massive compression based on the key expressions. These wavelets within the stream program can then flow through linear matrix operations to create financial indicators, or process the data to provide functions similar to those in a deep learning system.

With wavelake processing, edge data sets can be converted to internal useful features. For example, from edge web servers (e.g., JavaScript servers), the device data may be stored in JSON format, which is not directly usable by various deep learning systems. The JSON data can be used in trees, but slight changes between historical JSON data and real-time data feeds can dramatically impact the model performance. For this reason, the wavelake processing may be applied to convert JSON data to floating-point features, allowing a deep learning software to operate effectively. In some embodiments, the previous JSON edge data may be converted to a CSV file, which is usable by various deep learning platforms.

Basically, any network operation inside wavelake files can produce indicators, which can then be outputted to a CSV file. The outputted CSV file can be loaded into any open machine learning or modeling platform. In addition, since Hadoop wavelets can be intermixed with transactions, model development can represent how production data latency will affect the model. Depending on how the Hadoop-formatted wavelets are interwoven with historical transaction data, the effect of production latency can be built-in to the CSV output, assuring that the performance of the model in development does not degrade as it moves to production.

In some more advanced use cases, a time blur can be applied in the wavelet networks, for example, when edge or external systems have low service levels and/or high latencies. In wavelet networks, connections are communicated through a matrix, which by default is an identity matrix and does not change the wavelet. A “blur” operation can be performed in deep learning. With wavelets, if the starting phase is 1 hour, this can be blurred with the next phase by adding a Job Control Language (JCL) JSON to a connection to include a blur matrix to be multiplied by the wavelet. An example blur matrix is shown below.

$$[ \begin{matrix}5. & 0.5 & 0. & 0. \\ 0.5 & 0.5 & 0. & 0. \\ 0. & 0. & 1. & 0. \\ 0. & 0. & 0. & 1.\end{matrix} ]$$

The blur matrix would not completely eliminate the sensitivity to 1-hour changes in moving averages, but can smooth those changes with the 24-hour moving averages. This may be done because an external feed is supposed to be received every hour, but the data is frequently delayed. An issue with moving a full model to production could be that the production model does not perform as well as the model developed on historical data. Other options may exist where there are different costs in processing, for example, 1 minute feeds, 10 minute feeds, hourly feeds and daily batch feeds. These costs could be internal enterprise costs (e.g., the difficulty in moving batch processes to near real-time processes), but could also be related to the actual cost of data. For example, monthly batch updates may be considerably less costly than full real-time feeds.

By using the matrix in the connection creating the indicators, it can be assessed, in the development phase, whether it is worth the effort in moving daily batch processes to near real-time processes. In addition, analysis of service level production cost can be made as they impact models. For example, for an external system at a 95% service level (i.e., the system may be unavailable 5 percent of the time), a blur operation may need to be performed, which could incur a significant operations cost to move an edge system to, for example, the “five 9s” service level (i.e., 99.999% up time). By modifying the blur matrix, the degradation in performance could be low. In addition to making models more robust as they are moved to production, the model analysis can also assist in showing model performance gains if production system latency and uptime are improved.

The wavelake processing in the above embodiments can be run as a simple python shell command, which can be configured to read various non-binary files and to convert and/or compress the data into wavelets, which can be easily outputted as feature vectors for further downstream processing. In some embodiments, the wavelake processing can be embedded into the enterprise processing. For example, in a simple form, the wavelake processing may provide a lossy compression Linux shell command configured to massively compress logs from peripheral systems and convert these system logs into CSV files to be used directly by other machine learning tools. In some other embodiments, more advanced usages can be achieved, by having the wavelets act as complex spike neural networks to be fed to deep learning systems. The data processing method 200 described above can also be applied in systems (e.g., financial systems) having large big data platforms to solve the problems of messaging the significant amount of data into a proper format suitable for real-time data processing, which improves the overall performance of the system.

In some embodiments, the wavelake processing can be implemented by using a python file and a JSON control file to perform the data processing method 200 on the server 100. For example, the python file may be a library for executing one or more shell commands. The JSON control file contains definitions and control of the wavelake. In other words, the JSON control file includes site-specific details for performing wavelake processing. In some embodiments, the JSON control file defined in batch using the python module can be directly usable by language specific libraries.

In various implementations, a Linux shell file may be used to show options on how to run wavelake shell commands in various operating systems. For example, the shell commands can run in the Linux environment, or in the Windows environment using Windows Subsystem for Linux (WSL). It is noted that the wavelake processing can be performed without any other libraries aside from the base libraries that come with python, so the users can implement the wavelake processing in almost any environment without having compatibility issues.

In some embodiments, the wavelake shell command may use various parameters. For example, the parameters to be used may include a parameter (e.g., “-i”) for the input file in JSON line format (json per each line in the file), a parameter (e.g., “-c”) for the control file, a parameter (e.g., “-w”) for the wavelake file that will be read and updated, a parameter (e.g., “-f”) for formatting output to a standard output (stdout), a parameter (e.g., “-u 0”) for reformatting JSON lines or reading in unformatted data lines. In some embodiments, the shell command may send error messages to a standard error output stream (stderr).

For example, options for the parameter (e.g., “-f”) for formatting the output per line may include a first option (e.g., “-f a”) for abbreviated end node results in JSONL, a second option (e.g., “-f c”) for CSV output, a third option (e.g., “-f d”) for debug per line output in JSONL, and a fourth option (e.g., “-f h”) for Hadoop wavelake dump to a standard output (stdout), in a key-Tab-JSON format. In some embodiments, the fourth option can be used if many signals are being processed across hundreds of different servers, and these Hadoop formatted outputs can be merged by a final reduction wavelake. In some embodiments, Hadoop formatted lines as JSONL can be intermixed with normal transactions and allow updates of the wavelake from remote wavelakes.

In some implementations, a C++ library is available for systems requiring the moving averages with a short-term time frame (e.g., less than a minute). The C++ library may be required when the latencies of the wavelake processing need to be less than 1 millisecond. In some implementations, the C++ library may need to be modified to meet site specific requirements because the way C++ thread libraries interface with shared memory may be site-specific. For example, a C++17 library may allow wavelets to be created in embedded systems or used in extremely low-latency decision processing. Edge computers may run the wavelake python shell to create streams of wavelets, and then those streams may be merged in systems like Kafka/Hadoop/Milvus for usage in standard ML-OPS.

For extremely low-latency environments, wavelakes provides the C++ library for reading and updating the wavelets. The wavelakes C++ library does not provide a multithreaded database. However, it can update tens of millions of wavelets objects per second and convert them to feature vectors since the shared data system can provide the load. For example, the C++ library can be called easily with the header. In some embodiments, parameters in a C++17 template may include the timestamp data type, the wavelet value data type, and the number of phases. For example, in extremely real-time environments, the timestamp may be a fixed floating-point value in microseconds. If an external system like Hadoop is providing the wavelets, the loading of the wavelets into the C++ value and placing them into some type of dictionary is accomplished by the embedded systems software and is not provided in the library. For embedded systems, changes to the C++ headers files may also be required.

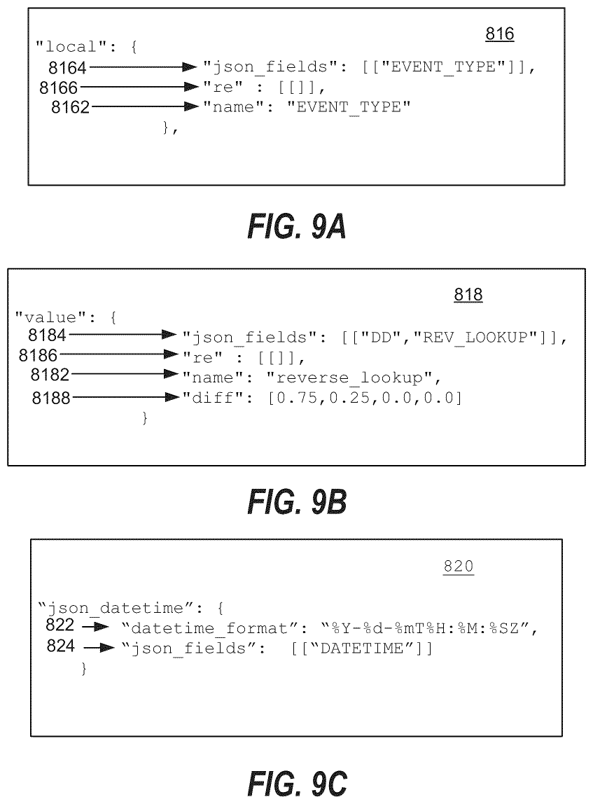

FIG. 7 illustrates an example JSON exported wavelet 700 from a wavelake for a single zip code, according to some embodiments of the present disclosure. In particular, after the wavelakes processing concludes, wavelake internals (i.e., internal parts of the wavelake) can be seen as JSON files. In some embodiments, these JSON files are often converted to compressed files (e.g., ZIP files), but can be accessible and viewable easily by ML-OPS personal. If a wavelake file is corrupted, the wavelake file can be replaced with an empty dictionary. As new streams occur, the empty dictionary will be refilled again. With the nature of the wavelets, as the data becomes older, the corresponding wavelet moves to zero over time. Thus, the wavelake processing can be used as a machine learning data engineering tool for complex petabyte data systems. While compression approaches like ZIP formats are normally not viewed by ML-OPS personal, the wavelake files are in a lossy compression format and it is often useful for ML-OPS personal to understand the wavelake internals.

As shown in FIG. 7, the wavelet 700 for the zip code may include multiple standard sub keys. For example, the “ptoken” 710 of the wavelet is a type of summing count of occurrences of the zip key. The “vtoken” 720 is a wavelet of the values defined normally in other wavelets, which can be a financial value. In the embodiments of FIG. 7, the vtoken happens to be “30.0” dollars for a series of transactions. For every phase of these wavelets, a moving average of dollar amount for each of the 4 phases can be calculated as follows:
30.0=30.0/1.0
30.0000117635=1.1325411719553813e-09/3.775135759553905e-11
30.0=11.036383234728962/0.36787944115763216
30.0=110.85349529797011/3.695116509932337

In general, internal mathematic calculations of the wavelets can be done with exponential vectors. Matrix operations can be used to perform operations similar to various functions like moving sums, averages, as well as complex reentrant convolution networks. In some applications, simple standard matrix operations can perform operations like moving averages and moving histograms, which can be delivered to standard machine learning programs as CSV arrays. In some embodiments, ML-OPS personnel may also add other data or feature to a JSON output of a wavelake.

It is noted that, while the JSON format is used as an example in FIG. 7, the present disclosure is not limited thereto. For example, for extremely low latency applications using C++ libraries, the wavelake files stored in thread and shared memory may have different formats, due to the high-speed environment and required specific management tools developed by ML-OPS and transaction processing engineers.

As mentioned above, the wavelake processing can be applied to produce one or more novel wavelake indicators easy to use by machine learning or deep learning systems, which may improve the performance of the ML systems. In particular, using traditional indicators and data in the ML systems is less efficient and accurate due to several common issues. For example, traditional or legacy indicators are not designed for neural networks and thus do not align well with these neural networks, such as multi-layer deep neural networks. It is also difficult to add additional data sources in the legacy sampling and selection processes. The data used for traditional or legacy models, such as decision trees, often results in poor performance in machine learning algorithms. Moreover, the real-time transaction systems may not align well with common ML libraries.

With wavelake processing, indicators can be re-engineered to provide beneficial properties which allow the use of modern ML practices and can simplify and improve current legacy processing. For example, wavelet-based indicators may be built on precursor events leading up to a transaction event. The wavelet-based indicators may be more stable and triggered significantly earlier than traditional indicators. By using wavelets to look at precursor events, a cloud of indicators can be built for simulating legacy indicators. Accordingly, the leading event data produced by edge processing can now be loaded into the storage device (e.g., RAM) for real-time decisioning.

Taking a simple XOR feature as an example, an XOR indicator triggers in response to a change in the value. For example, if two transactions in a row are either 0 or 1, then the output of the network is 0. If either transaction changes, then the output is 1. With a standard neural network node, where the rectifier is often either a rectified linear unit (ReLU) or a hyperbolic tangent (TANH) activation function, it is problematic to output a classic XOR indicator. A standard neural network node can be defined as:

Rectifier(Σwᵢ*vᵢ)

In the above neural network node, vᵢ represents i-th input, and wᵢ represents a weight for the i-th input.

On the other hand, with a wavelake network, a single connection can perform the XOR indicator. In some embodiments, possible matrix operations per network node for the XOR indicator can be expressed by the following general equation:

$$Rectifier ( \sum {wavelet}_{{vector}_{i}} ⊗ \frac{{Filter}_{{matrix}_{i}}}{{Bias}_{{vector}_{u}}} ⊗ {Weight}_{{vector}_{i}} )$$

In the above equation, Rectifier(Σwavelet_{vector}_{ᵢ}) is needed for the wavelake network to perform the simple XOR indicator. For example, depending on the phase (i.e., the time between transactions), the wavelet may be [[1, 0, 0, 0], [0, 1, 0, 0] ] for two changing transactions, or [[0, 0, 0, 0], [1, 1, 0, 0]], for two transactions in a row with zero's or one's. By applying a rectifier option called “full duplex” with a vector (vector2scalar) specified as [1,−1, 0, 0] in the JSON control file to convert the vector to a scalar value, the following expressions can be obtained:
rectifier([1, 0, 0, 0]*[1, −1,0,0]→rectifier([1*1,0*−1,0*0,0*0])→1
rectifier([0, 1, 0, 0]*[1,−1,0,0]→rectifier([0*1,1*−1,0*0,0*0])→1
rectifier([0, 0, 0, 0]*[1,−1,0,0]→rectifier([0*1,0*−1,0*0,0*0])→0
rectifier([1, 1, 0, 0]*[1,−1,0,0]→rectifier([1*1,1*−1,0*0,0*0])→0

In some embodiments, a rectifier converting a vector to a scalar may apply a ReLU type function before adding the vector and/or after generating the scalar. In the present example, the rectifier can be applied before and after the vector sum operation. In addition, the rectifier may perform rectification in both positive and negative directions, as well as optionally absolute value rectification (e.g., full duplex). When multiple transactions come in within the phase (e.g., at the same time), then the phase shift may affect how values are stored in the wavelet. As stated above, the phase value indicates the time between transactions. For example, if the phase value is set at 60 seconds, the XOR indicator requires the differences to occur across a time frame greater than 60 seconds, that is, two different types of transactions need to come in at least a minute apart.

While the simple XOR indicator is taken as the example above, more complex indicators may be built. For example, an indicator may be used to examine the trending of a MACD indicator along with the volatility of the trend (i.e., how much the MACD value is changed per trade). A trending MACD indicator may be a vector change to the XOR function described above. If a MACD is calculated based on a one-month MVA versus a one-year MVA, a vector [0.33, 0.33, 0.33, −1.0] for the scalar multiplier can be applied with standard phases. The result can be fed back into the wavelake as a value for starting a new wavelet. Therefore, a wavelet representing the moving average of the MACD value can be obtained. Then, another connection in the channel can be provided to subtract the current value from the moving average of the MACD value. In other words, with a wavelake network, rather than having connections fanning out as in a traditional neural network, multiple connections can be chained together to recreate a more complex wavelet-based indicator. After the indicator is obtained, various processing can be performed based on the wavelet-based indicator. For example, the wavelet-based indicator may be fed back up into a real-time system.

In some embodiments, the obtained wavelake indicators may be specific to financial analysts' intent but may not be actual duplicates of the traditional indicators. The one or more novel indicators obtained according to the conversion of traditional indicators to wavelakes may be easy to use by deep learning systems. For example, the wavelake indicator may have the properties of floating values and continuous values, which are not hard-limited, and thus may be suitable for various deep learning systems. In some embodiments, when converting indicators to neural connections, the wavelake processing may provide a 4-state rectifier function to perform half and full duplex, and also return the remainder value, rather than the clipped value normally returned in ReLU functions. In some embodiments, the wavelake processing may provide a circular horizontal and vertical rectifier function to normalize the wavelets values into balanced histograms. In some embodiments, the wavelets may be re-entrant. Alternatively stated, any network point can return the final scalar value back into the wavelake when the processing is completed, to create a new wavelet type under a primary key. Based on the features above, a network read from the wavelake using wavelet matrix or tensor multiplications can work with traditional indicators, traditional neural networks, deep and spike neural network structures, or the like. In some embodiments, high-speed decision tree operations may also be available to convert multiple wavelets into decision categories.

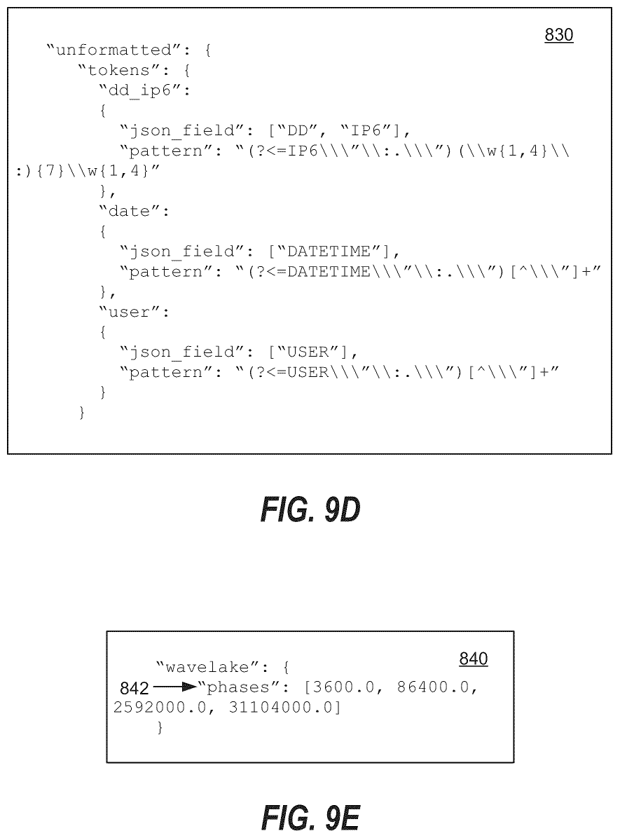

FIG. 8 is a diagram illustrating an example general dictionary hierarchy 800 of a control file, according to some embodiments of the present disclosure. As shown in FIG. 8, the dictionary hierarchy 800 may include top-level dictionary groups 810-850.

The top-level dictionary group 810 named “primary_keys” may include subgroups or lists 812, 814, 816, and 818. For example, the list 812 named “json_fields” may be a multiple level list, and is a list of lists. The top-level list 812 can be used to aggregate JSON fields, the list(s) within the list 812 may be the reference point inside JSON to get to the appropriate JSON field.

In some embodiments, the list 814 named “re” may be the top-level list, which is aligned to the list 812. For each field, a regular expression can be used to pull the appropriate string.

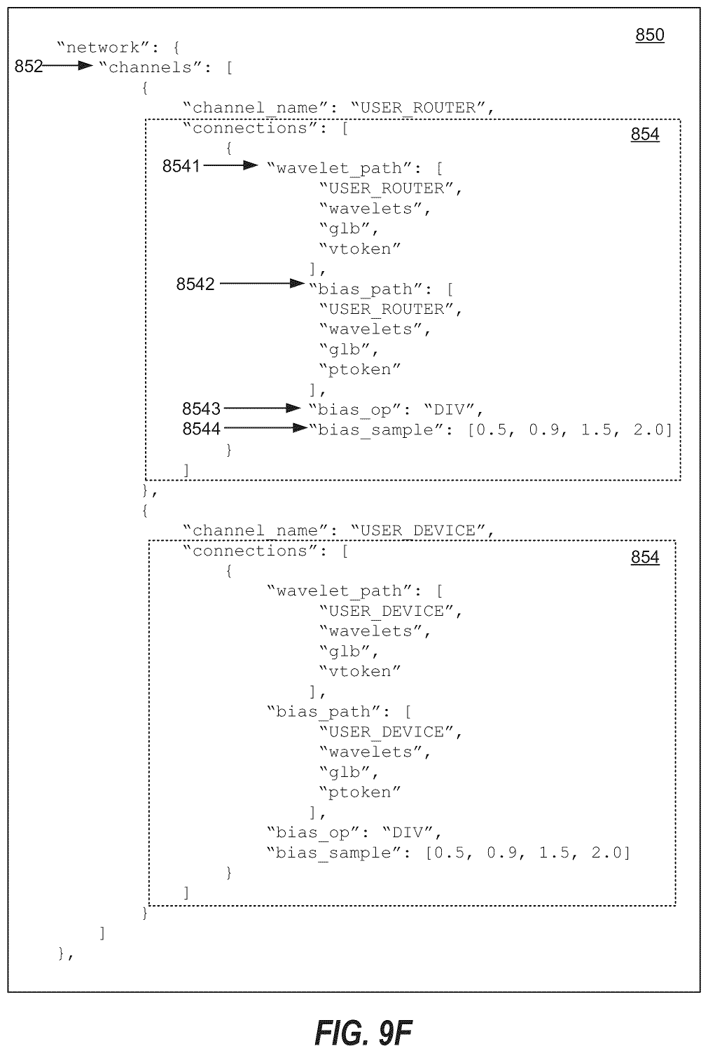

In some embodiments, the subgroup 816 named “local” is a dictionary sub-group configured to define a key dictionary which will be stored within the primary key blob. The subgroup 816 includes a “name” token 8162 to define the subtoken name, along with a “json_fields” token 8164 and a “re” token 8166. FIG. 9A illustrates an example of the subgroup 816, according to some embodiments of the present disclosure.

In some embodiments, the subgroup 818 named “value” is a dictionary sub-group configured to define a wavelet type of the value which will be stored within the primary key blob. For example, the value path is normally a floating-point number.

Similarly, the subgroup 818 includes a “name” token 8182 to define the subtoken name, along with a “json_fields” token 8184 and a “re” token 8186. FIG. 9B illustrates an example of the subgroup 818, according to some embodiments of the present disclosure. As shown in FIG. 9B, a “differential” token 8188 may be found within the subgroup 818. The “differential” token 8188 may be a vector used to covert the current mean value into a value representing the standard deviation and create a corresponding dtoken wavelet.

The top-level dictionary group 820 named “j_son_datetime” includes a “datetime_format” token 822 and a “json_fields” token 824. FIG. 9C illustrates an example of the dictionary group 820, according to some embodiments of the present disclosure. As shown in FIG. 9C, the token 824 may be “% Y-% d-% mT % H: % M: % SZ,” which is a standard parse definition for datetime. The “json_fields” token 824 may be a single field specifying the datetime.

The top-level dictionary group 830 named “unformatted” is configured to take any text line and convert each line to a JSON format. FIG. 9D illustrates an example of the dictionary group 830, according to some embodiments of the present disclosure. The dictionary group 830 can also be used to remap JSON lines having problems, or having leading or following data that creates non-standard JSON. For example, with error logs in JSON fields, the error log is normally not a JSON statement. The dictionary group 830 can be used to remap non-standard JSON format like error log or web logs into standard JSON format. As shown in FIG. 9D, in some embodiments, the json_field array is just for a single field, but can create a hierarchy to assign the field. The pattern may be the standard regular expression pattern for python. If the corresponding token is not found in the regular expression, then no standard JSON token is created. In some embodiments, when running with debug, a raw output data may be the reformatted JSON, in response to a corresponding parameter (e.g., “-u 0”) for reformatting JSON lines or reading in unformatted data lines being chosen.

The top-level dictionary group 840 named “wavelake” may contain a single “phases” token 842, which includes a list of phase delays in seconds. FIG. 9E illustrates an example of the dictionary group 840, according to some embodiments of the present disclosure. As shown in FIG. 9E, the “phases” token 842 is an array of time phases in seconds by default. That is, the value of 3600 represents 1 hour starting phase. In some embodiments, each phase may be considered as a beta summed cascade, and what is normally zeroed from the beta sum is carried to the next phase and uses the next phase time value. The delta time on the exponential is from the time stamp of the incoming transaction to the time stamp of a possible pre-existing wavelet. Diagrams of the phase/cascade relationship of the wavelets include those described in U.S. Pat. Nos. 10,445,401, 10,789,330, 10,789,331, and 11,036,824, contents of all of which are incorporated herein by reference in their entireties.

The top-level dictionary group 850 named “network” can be used to build various functions or neural networks. All the inputs and outputs of the network may be either wavelets or scalar conversions of the wavelet. In the network, bundles of connections may be processed in channels. Channels and connections within the channel may both be sequential lists in JSON and not dictionaries. Thus, unlike a traditional neural network where the order of the connections does not affect the summing operation, the order that connections are placed in channels, and how connections are processed are all ordered.

In the dictionary group 850, the “channels” list 852 includes an ordered list of connections 854. In some embodiments, the dictionary group 850 may include a “vec2scalar” token 856 configured to be multiplied by the output of the channel, so as to convert the vector value into a scalar value. The connections 854 can be processed in a wavelet accumulator, which is stack-based. When a complete channel is processed, the output can be optionally converted to a scalar, then have the scalar update the wavelake with the result.

The connections 854 in the dictionary group 850 are similar to traditional neural network connections but passing a wavelet. The connections 854 may be a grouping of single connections and considered as a node. Each connection 854 may include a “wavelet_path” token 8541, a “bias_path” token 8542, a “bias_op” token 8543, a “bias_sample” token 8544, a “result_path” token 8545, and a “vec2scalar” token 8546.

In the default mode, the “result_path” token 8545 is used to update the result path. For example, the “result_path” token 8545 is used to output the results of either a single connection or channel back into the wavelake. Three “path” tokens 8541, 8542, and 8545 have the same format, which may be an internal path to both a temporary wavelake file and the full wavelake file. By default, the return of each connection 854 can be placed on a wavelet stack. The next connection 854 can be configured to either pull a single wavelet from the stack, calculate the sum of wavelets to a starting wavelet from the stack, or pull a wavelet, from the wavelake log, which has changed on the current transaction.

FIG. 9F illustrates an example of the dictionary group 850, according to some embodiments of the present disclosure. For each connection 854, the values of the “wavelet_path” token 8541 and the “bias_path” token 8542 can be respectively received from a wavelet. The “wavelet_path” token 8541 and the “bias_path” token 8542 are followed by a list for lookups into the temporary wavelake file. The “bias_op” token 8543 represents an operation type for the bias, when it is present. For example, the value of the “bias_op” token 8543 may be normally “div,” but the present disclosure is not limited thereto. If the “bias_op” token 8543 is not present, then no bias operation occurs. When a bias occurs, the minimum amount of samples per phase may be required. The “bias_sample” token 8544 is followed by a list of the same size as the phases and represents the minimum samples required in the phase group, for a non-zero result for the bias.

In some embodiments, the “vec2scalar” token 8546 is present on the same level as the “result_path” token 8545. The “vec2scalar” token 8546 may be a vector configured to be multiplied by the output of the connection or channel, so as to convert the vector value into a scalar value. For any operation of converting the vector value into the scalar value, a parameter scalar_relu can be used for different types of rectifiers. For example, the value of the parameter scalar_relu can be a string. If the value includes “f” in the string, then an absolute value rectification (e.g., full duplex) is performed. If the value includes “r” in the string, it may be the value external of the bias (what is clipped). In addition, for any operation of converting the vector value into the scalar value, an optional control parameter scalar_relu_control can be used. The value of the control parameter scalar_relu_control may be normally 1.0, if the token is not present (i.e., like a standard ReLU function).

In a “pop” operation, the number of wavelets on the stack can be pulled, via an integer variable referenced by sum, from the wavelet stack to sum the wavelets. For example, the operation of summing three connection wavelet results on the stack into a new wavelet can be expressed as: {“pop”: 3}.

In a “push” operation, after a wavelet stack sum operation from a pop, the wavelets result can be directly saved if the push variable is anything but an array. If the push variable is an array, then that push is placed on the stack. Each phase can be pushed as a new wavelet onto the stack, or just the current wavelet is pushed onto the stack. When the value of a push parameter is zero, the current wavelet is pushed onto the stack. When the value of the push parameter is a positive number, each phase of the wavelet is pushed onto the stack as a new wavelet, and the new wavelet size is based on the positive number. In some embodiments, in addition to the default push on the accumulator at the end of the connection, there may only be one additional push per connection. For example, the operation of pushing the pop operation as a copy onto the stack can be expressed as: {“push”: 0}. The operation of pushing each phase of a wavelet into a new wavelet of depth 1 can be expressed as: {“push”: 1}.

In some embodiments, a “flush” operation can be performed to read from the stack wavelets, merge the wavelets into one single wavelet, then push the single wavelet onto the stack. For example, the operation of converting the last 3 wavelets on the stack into one larger wavelet can be expressed as: {“flush”: 3}, in which the parameter value 3 would take the last three wavelets on the stack, then merge the arrays end to end. If the new wavelet needs to be placed on the stack, then a push operation is needed.

In some embodiments, a “pretransform” operation may occur after the optional pop operation and optional push operation. For example, Rectified Linear Unit (ReLU) and hyperbolic tangent (TANH) are two general transform functions. In addition, the wavelet can be modified by the “carry” of the result of the transform moved into the next wavelet phase. In some embodiments, a parameter value of “tanh” represents performing a standard TANH operation on the first value in the wavelet, while a parameter value of “relu” represents performing a standard ReLU operation on the first value of the wavelet. In some embodiments, the default operation may be performed with a parameter value of “reluh,” which moves all phases to a 0 to 1, based on the total amount in the wavelet. For example, the operation of performing a standard TANH operation can be expressed as: {f“pretransform”: “tanh” }.

In some embodiments, various matrix operations can be performed. In various embodiments, either a matrix or a vector can be multiplied by the wavelet. For example, the matrix may be an identity matrix. An example identity matrix is shown below.

$$[ \begin{matrix}1. & 0. & 0. & 0. \\ 0. & 1. & 0. & 0. \\ 0. & 0. & 1. & 0. \\ 0. & 0. & 0. & 1.\end{matrix} ]$$

For example, the matrix may be a blur matrix to be multiplied by the wavelet. An example blur matrix is shown below.

$$[ \begin{matrix}8. & 0.2 & 0. & 0. \\ 0.1 & 0.8 & 0.1 & 0. \\ 0. & 0.1 & 0.8 & 0.1 \\ 0. & 0. & 0.2 & 0.8\end{matrix} ]$$

For example, the matrix may a traditional neural network matrix providing various weights. An example neural network matrix is shown below.

$$[ \begin{matrix}0.3 & 0. & 0. & 0. \\ 0. & - 2. & 0. & 0. \\ 0. & 0. & 1.6 & 0. \\ 0. & 0. & 0. & - 0.1\end{matrix} ]$$

In some embodiments, the example neural network matrix above can be run more efficiently as [0.3, −2.0, 1.6, −0.1].

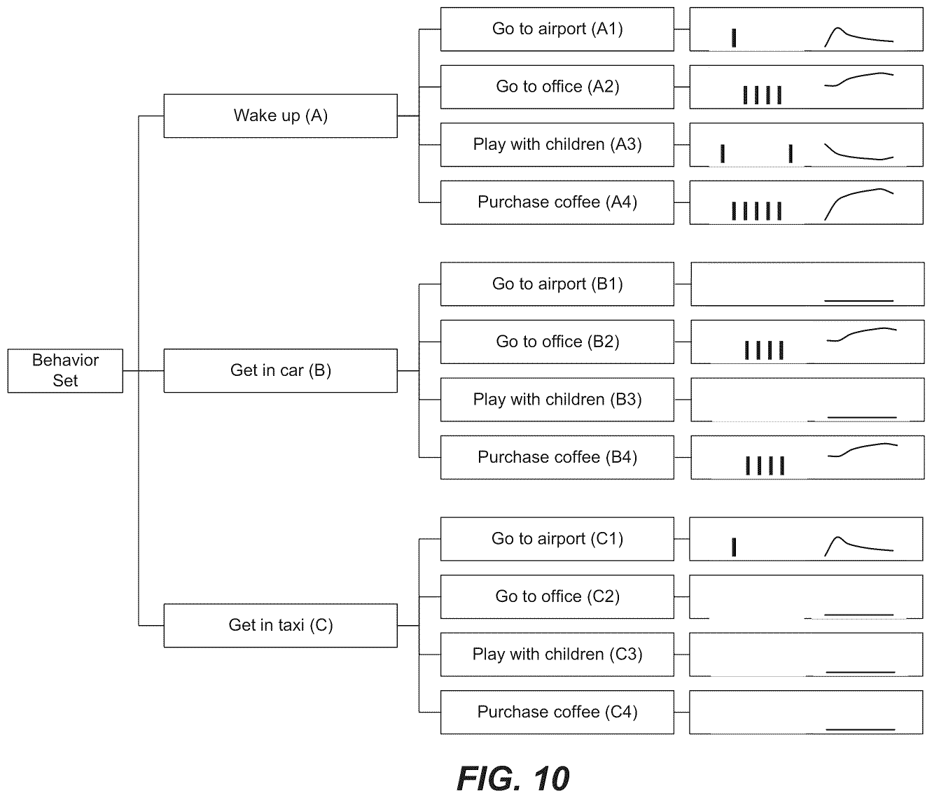

FIG. 10 is a diagram of wavelet construction based on permutations of behaviors, consistent with some embodiments of the present disclosure. As shown in FIG. 10, wavelets representing a person's activities may be constructed based on permutations of behaviors. The illustrated behavioral set, which may form the basis of constructing a wavelet, includes three first actions corresponding to indications and four second actions corresponding to indications, for a total of twelve possible action sequences. For example, a person may wake up (A), get in his car (B), or get in a taxi (C). Indications of each action may be an alarm on his phone, a remote start using an app on his phone, or calling a taxi operator, respectively. After each of these first activities, the person may go to the airport, go to the office, play with his children, or purchase coffee. Combinations of actions may produce, for instance, thousands of networked events and transactions, which may be converted into wavelets and propagated through neural networks, such as in real time or in batches.

Further, each sequence may be associated with a frequency. As shown in FIG. 10, the person wakes up and goes to the airport (AI) once per week, as illustrated by the corresponding histogram. The person also gets into the car and goes to the office (B2) four days per week. As another example, the person gets in a taxi and plays with his children (C3) zero days per week. In some embodiments, histogram counts as illustrated in FIG. 10 may be smoothed or analyzed using a moving average, as illustrated in the graphs adjacent to respective histograms in FIG. 10. Thus, the transformation applied to the signals may be a smoothing function, for instance. Additional data conditioning and transforming techniques may also be used for generating wavelets, such as outlier removal, “squishing” functions such as hyperbolic tangent and other sigmoid functions, a Dirac function, Fourier or Laplace transformations, and the like.

FIG. 10 illustrates a simplified behavior set for a person, but real-world behavior sets have thousands or even millions of sequence permutations. Further complicating a behavior set is that some sequences may be redundant. For example, “wake up and go to the airport” (AI) occurs at the same frequency as “get in taxi and go to the airport” (C1). Additionally, permutations may be reversed. That is, while FIG. 10 shows “get in car and purchase coffee” (B4), a full behavior set would also include “purchase coffee and then get in car.” Additional sequence layers (3, 4, 5, etc.) may also be added to provide more thorough actions sequences, such as wake up, play with children, get in car, go to office.

Training models with potentially millions of permutations and sequences of indefinite length results in long training periods for neural networks and other models, as well as high latency for anomaly detection and predictive analysis. Thus, in order to reduce latency, the behavioral set may be trimmed. For example, in FIG. 10, the sequence “get in taxi and go to office” (C2) has a frequency of zero, indicating that the person never takes a taxi to the office. Likewise, the sequence “get in car and go to airport” (B1) also has a frequency of zero, because the person never drives his car to the airport. Thus, these low-frequency events may be eliminated to increase training speed and decrease latency of models.

Similarly, wavelets may be constructed based on occurrences of word sequences in text. Further, a sequence may be one item. For instance, a sequence may be the occurrence of the word “hypothesis” in a book, and occurrences of the word “hypothesis” in the book may be used to create a wavelet. In addition to discrete data points, continuous signals, such as data measurements from a temperature sensor, stock prices, blood pressure and other health metrics, may also form the basis of a wavelet. Details of the relationship between the wavelets and financial behaviors include those described in U.S. Pat. No. 11,182,675 and U.S. application Ser. No. 17/529,690, contents of both of which are incorporated herein by reference in their entireties.

In some embodiments, behavioral finance indicators can be built from edge servers logs and used with transactional central server processing. In a persona template for behavioral finance, generated data can be used so test cases can be run as a starting point for site specific implementations. In some cases, the edge event data for the wavelake processing may not be available to central transaction processing, and a task is to provide wavelake indicators available to a central modeling group that is responsible for final models or decisions. Possible use cases for the central modeling group may include suggesting portfolio distribution changes through account executives, or sending suspicious activity reports to investigations. In some embodiments, a persona template for behavioral finance may also be copied for test or evaluation, as all data used is generated and not based on real account holder data.

For example, a shell script can be used to run the template. In the first step, data from the edge sensor (e.g., firewall, customer support log, etc.) can be converted into a wavelake stream. The wavelake stream may be line-delimited, where each line is a segment of the wavelake with a routing key followed by a tab. Thus, standard open source packages like Hadoop can receive the edge data. In the present embodiments, no big data package is required to perform wavelake tasks, as the default program can do all stages of the processing in a linear manner. For example, in some installations, there may be thousands of edge logs that are normally not made available for central processing, so the first step of the shell script would be run at the edge servers.

In the second step, the wavelake streams are merged into a single wavelake and/or segmented wavelake, when used under Apache open source software such as Hadoop. In some embodiments, old and out of time sequence streams can be merged into a single wavelake, and no sorting of data is required. The output of the second step may be a JSON file, which can often be compressed if it is transferred to another location. The compression may happen automatically in various Hadoop installations.

In the control file for this reducing step, the phases vector is needed for merging streams. It is noted that the phases are exponential. For behavioral finance, there are often system 1 versus system 2 behaviors (e.g., short-term emotional behaviors versus long-term behaviors). In some embodiments, the outputs of the reducing step may include wavelets that represent standard system 1 versus system 2 behaviors in a wavelet format.

In many cases, the edge logs keys are not available for joining for central processing. Accordingly, this reducing step refers to the wavelakes generated on the edge but could be based on completely different transaction logs. For example, an account or user key is often used in central systems, and data such as IP6 address wavelets need to be converted to the central system keys. In the control file, the switches and keys can remove edge log detailed data to enable central decisioning.

In some embodiments, the wavelets are also converted, so they can be uploaded into central processing key stores or be made available to standard decisioning methods. The network control information is also required to output the final data. It is noted that in more complex networks, there can be multi-channel order that is important, but the present disclosure is not limited thereto.

In the third step, behavioral reference indicators are built. The final output line can be sent as a standard output file. The output file can be converted to a CSV file or other common file format. In some embodiments, the JSONL format is parsed so that top level tag is the indicator, with the corresponding tag (e.g., “ptoken” tag) followed by the key (e.g., the user/account key) to be used by the central system. The vector shown at the end of the output file may be the moving averages of the “riskiness” of the devices used by the specific user for the specific transaction. For example, high ratios in system 1 times (the first two phases) versus low ratios in system 2 times (the second two phases) are often an indicator of bad actors or behaviors. In some embodiments, in the third step, a new wavelake file representing the running risk issues can also be stored in the wavelet format for the account.

For converting edge logs into wavelet streams in the first step, it is required to understand what fields are in the edge logs and their formats. As stated above, for each core financial transaction, there may be hundreds of leading edge events, which can build up a behavioral profile for the transaction. In some embodiments, the wavelake processing can be performed by using a single python program (e.g., running python 3.8), installation of which is a fairly easy activity to complete in edge locations.

For various edge streams, ML-OPS personnel may start wavelakes with building basic statistics counting the data being collected at the edge. When edge issues are found, a small wavelake model or indicator can be created on the edge to create priority ordered lists. Finally, once wavelet processing is understood and evaluated, then all edge logs can be streamed to central ML-OPS. The above process may often be different based on the major subsystems (also known as edge systems in this area) that may be fed into central financial processing. In some embodiments, multiple integration options may be used for the major edge systems found in financial ML-OPS. In many circumstances, there may be risk systems in place in those subsystems that are prerequisite in order to provide a successful wavelet strategy. In some embodiments, if edge logs are centrally managed, then it may be a fairly easy task to map the logs into wavelets streams. For some subsystems, the data will need to be extracted, ran through a wavelake processing, and then sent to the central ML-OPS.

For call center edge streams, call center operations interacting with customers over phone devices may be an important location for building behaviors, which shows Account Takeover (ATO) and related issues, where a current account is having its profile updated by a fraudster. For businesses having large seasonal peaks, it's also an area where seasonal employee issues arise, as a seasonal employee may access an acquaintance's account information. These two different problem cases may require different stream processing. The reason for breaking out the employee case from the remote account takeover is that account takeover behaviors should normally stream to central processing, while employee issues will have general account takeover behaviors sent to central processing and anything else to investigation servers. The overlapping behaviors between these two cases may include address changes, email changes, adding secondary users. In the following examples, the general account takeover implementation approaches will be discussed. However, it is also noted that some fields should not be converted to general stream keys (e.g., employee ID) for call center edge streams.

For the call center, the customer phone number may be normally used as a key in generating the wavelet, but any common repeating field that may be available via phone ID services can also be used. In traditional call centers, the data may be pure voice/analog, but now many call center functions can intermix with SMS and text chat through web functions. In some embodiments, it is required to convert any channel that can update a customer profile to the wavelet stream, as fraudsters may identify and use the channel with less controls. To minimize the system impact, a key defined in the wavelet control file and one local subkey may be required. For example, a common/important local key may be the event type, such as email changed, phone number added, or address change. During the customer interaction, various problems or errors may occur. For example, the customer cannot complete the authentication, the customer call is dropped by the customer side, the customer call needs to be forwarded to another location. At minimum, two fields need to be converted from a customer service log. For example, the problem field is normally the event type, and the event/change can be stored in different fields. The fields can be merged to create the local key.

In some embodiments, in the wavelake control file, multiple JSON fields can have multiple regular expressions to create a single key. The regular expressions used by wavelakes can be the standard expressions provided in python. Complex integration of fields can be done with regular expressions, which are industry standard. However, it may not be easy to create regular expressions, and thus at a certain level of regular expression complexity, a pre-processing step may occur before calling the wavelakes. Accordingly, debugging items like creating two JSON fields (e.g., phone number and event type) may occur in the user-defined codes (e.g., a small python program), and the wavelake control file can be kept simple.

For call centers, the phone log may not be stored with all the fields, but may be maintained with a subset of field in a relational database. In these cases, a trigger is needed in the relational database to write a log, or the relational database should be queried periodically to create a log. These extraction logs can then be run by calling the wavelake program in the standard method. In some embodiments, significant events can be found with just a few fields, and it is not required to convert all fields. In some embodiments, any call center interaction that can change an account state should be streamed. If a score is currently produced in the processing, the score may be a value to forward in the stream.

For enrollment edge streams, they are often better thought of as large complex systems having a much smaller stream feeding into the core financial behavior systems. Thus, there may be different use cases for wavelake installation in enrollment systems. For the use case of the enrollment fraud, the entire wavelake process may be contained in the enrollment system, and only a subset of high-level keys may be sent to central behavioral systems. In some cases, the support for an entire wavelake system may be needed. For the use case of enrollment seed keys or enrollment velocity keys, only a small subset of important keys may be forwarded to core behavior systems. The enrolment device information may often be forwarded to seed the external wavelake, and only simple stream maps of log files may occur in the wavelake control file.

The enrollment seed keys and enrollment velocity keys may be the two primary groups of wavelets that are sent from the enrollment edge to central ML-OPS. In both cases, the common keys may include the standardized address (e.g., the address of enrollee going through address normalization), the phone number, the email address, and device information. In some embodiments, historical joins may be done to resend initial wavelake events, because the initial events may sometimes be hard to categorize. For example, types of data to resend to the central ML-OPS may be based on the problem events, including a fraud address, a fraudulent user, a package not received, a “bust-out” type of frauds (e.g., a valid user who leaves the country after an event).

For example, the seed data may be simple device information used during the enrollment that is then expected to re-occur for normal financial interactions. Some of the seed data should also be sent to the customer's relational database records that actually enable further interactions (e.g., an email validation). The email validation process provides a good example, where the wavelets are good for looking at momentum issues.

In some embodiments, some fields are not appropriate to be forwarded as wavelets to the central ML-OPS. It may be required to look for fields which help identifying devices, to prevent later account takeover. The wavelets can be significantly modified to minimize privacy concerns, which also helps in the key compression process.

For web server edge streams, customer interactions with reading web pages can be used to build up the users' financial behavior. For example, this can be done by simply counting how many texts and images the customer requests with “gets.” These text and image gets can be local keys and tracked separately. A customer's behavior may be understood by looking at what they read. In some embodiments, high level tab interaction may be useful in identifying basic customer interests. If the website provides a simple UI interface, this can be done via the wavelake control file. More complex websites, and websites that are real-time defined through java script, often have web logs that are more complex to parse. The complex web logs may be parsed with as much normalized URL data as possible, and may also be saved to the JSON file with all device information collected. For example, the device information to be collected that is useful for financial fraud analysis may be obtained from open public EMV specifications.

In addition to account takeover behaviors, phishing analysis and other hacker-type of screen scraping can be done using the wavelets. For phishing type of fraud detection, it may be necessary to build up a significant amount of background wavelet information, such as even standard data cached by providers for images and documentations that are often downloaded by the users' browser pre-login. Thus, cloud cached “get” data statistics can normally be moved through wavelakes on a different server than web page URL interactions.

Because the time between web interactions and actual financial transaction may be shorter than a minute, near real-time batches may be set up between the edge and central ML-OPS. Data for general investigations (e.g., detecting new phishing programs) can be delayed, but fraudulent transactions on devices with high issue frequencies need to be processed quickly. In some embodiments, most “bad” actor devices identified in the velocity checks should be sent to ML-OPS quickly. In the scenarios where the volume of the wavelet data may become too large for central processing, the behavioral indicators may be created on the edge, and only high risk indicators may be sent for real-time processing based on high risk behaviors (e.g., high velocity IP6 issues). In some embodiments, the web server edge streams can be used for looking for events such as starts of new phishing scams in larger batches, which can be sent for further investigations.

For firewall edge streams, various significant external issues may be used for building behavioral profiles to assist in detecting client computer's compromises. In some cases, a main issue may be the volume of issues reported in the firewall logs. At minimum, basic IP statistics can be streamed into daily wavelake file for aggregate bias statistics, especially for cross-border IP issues. In general, edge systems may rely on external vendors to check on device issues, but depending on the size of the financial system, significant data may be produced by the internal firewall logs. If a financial system is targeted specifically by fraudsters, or if there is a cycle of organized attacks, then the wavelets can be used for looking for the initiation of the cycle. In general, external providers may show problematic IP activity in a wider context. In some cases, the volume issues may constrain the keys to country-level information, to focus on the cross-border information.

For simplicity, daily aggregate wavelake stream tasks can be run due to the volume of firewall issue logs. In some embodiments, IPV4 only to key may be on the first few octets. For IPV6, the regular expression may only target the “top” section. If detailed analysis is required, larger sections of the IP fields may need to be processed by the regular expression, which may greatly increase the RAM size of the wavelake as well as the file storage. The compression ratio of the wavelets may be primarily determined by the randomness and size of keys. If, for example, a fraudster can randomly move through any device ID within the IPV6 section, then a large number of generated devices may have their key created. This could be useful if the generated device key is re-used, but normally the generated device IDs in the IPV6 section are used for short periods of time. The opportunity for this type of information is to only look at the most recent wavelet information and freely purge wavelet phases older than one month.

For login server edge streams, login server behaviors may be related to other edge logs, and in some cases wavelet streams may flow back from ML-OPS servers to the edge login servers. In all cases, field conversions, such as password success/failures by IP keys, may provide lift. There may be model logic in the login server to force the remote user into secondary authentication, and any secondary authentication actions may also be logged and converted into the wavelet streams. For some problematic locations, such as shared university environments or shared computers for elderly, the financial behavior of the device may flow to the central ML-OPS. The central ML-OPS may have models configured to kick larger transactions into exceptions based on moving averages indicating fraud issues. In some embodiments, this may also be done in conjunction with the login server rule system, which should have ACID properties (atomicity, consistency, isolation, and durability) of database functionality.

In addition to the fraud issues, some institutions may have significant population of customers transitioning between cognitive stages. Customers showing progressive cognitive issues could also have that behavior forwarded to the account management. Customer frustration is a key factor in customer management, especially for customers having limited experience with modern computer interfaces. Also, elderly customers often have a high volume of scam phone calls they are fielding, and thus it's important that they don't fall prey to schemes where they give up their passwords.

It is noted that there are various behaviors that may lead to login issues, and many of them are not fraud. It is also noted that fraudsters may create confusion to “phish” valid clients, and the relationship between the login streams and the profile management streams may be a key integration area to prevent frauds.

For customer appointment edge streams, for some financial systems, a significant amount of interaction with the customers may be done via account executives. This relationship may improve the process flow, especially when “problem” behaviors have been identified in wavelake indicators. Also, if there is a high ratio of problem indicators, it might be of benefit to enable call backs to clients. For example, another solid mechanism is that the call function can provide an automatic second factor authentication for the account executives as the clients' device information is stored during the call. Thus, the device information during the appointment process should be fed back by a wavelake process back to central ML-OPS as validated device information. In some embodiments, using voice channels between known parties may be a method for having two-factor validating to lower the risk of future financial events.

When upgrading account management systems, implementing the hooks may be a way to save device information during the appointment. In some cases, the appointment system does not provide an interface for storing the log information, which may be a problem for feeding wavelet streams of validated device information back to the central processing. Thus, this should be viewed as a high priority task when updating appointment systems. If the current appointment system has these hooks, then it is a fairly low-cost and low-impact way of having validated device data fed back into the central systems.

By the various embodiments of the present disclosure, the proposed systems and methods may achieve various improvements. In particular, system logs recorded by various conventional systems may accrue. However, the non-binary system logs are not suitable for conventional machine learning systems and thus become obsolete without further use. In the disclosed embodiments, useful features can be extracted from these logs, regardless of their format or content. Accordingly, the system may allow for edge event monitoring through available edge data, provide powerful data to power downstream Als, enable real-time complex decision-making.

In some embodiments, a non-transitory computer-readable storage medium including instructions is also provided, and the instructions may be executed by one or more processors of a device, to cause the device to perform the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that includes one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

The embodiments may further be described using the following clauses:
1: A data processing method, comprising: receiving input data associated with a plurality of transactions; generating, based on the input data, a plurality of wavelets corresponding to the plurality of transactions; storing the plurality of wavelets and corresponding keys associated with the wavelets in a key-value database; and outputting, based on the plurality of wavelets, one or more indicators.
2: The data processing method as paragraph 1 describes, further comprising: converting the wavelets into the one or more indicators according to a filter matrix, a bias vector, and a weight vector.
3: The data processing method as either of paragraphs 1 or 2 describe, further comprising: receiving a plurality of edge logs from one or more edge nodes, a plurality of external data feeds, or a combination thereof as the input data.
4: The data processing method as any of paragraphs 1-3 describe, wherein generating, based on the input data, the plurality of wavelets comprises: generating one or more first wavelets from the input data; and deriving one or more second wavelets from the one or more first wavelets.
5: The data processing method as any of paragraphs 1-4 describe, further comprising: feeding the one or more indicators to a deep learning system for real-time processing.
6: The data processing method as any of paragraphs 1-5 describe, further comprising: merging a plurality of key-value databases storing the plurality of wavelets into a single file or a segmented file.
7: The data processing method as any of paragraphs 1-6 describe, further comprising: storing the key-value database into a memory in a data serialization format.
8: A system for processing data, comprising: a memory device storing a set of instructions; and one or more processors configured to execute the set of instructions to perform: receiving input data associated with a plurality of transactions; generating, based on the input data, a plurality of wavelets corresponding to the plurality of transactions; storing the plurality of wavelets and corresponding keys associated with the wavelets in a key-value database; and outputting, based on the plurality of wavelets, one or more indicators.
9: The system for processing data as paragraph 8 describes, wherein the one or more processors are configured to execute the set of instructions to further perform: converting the wavelets into the one or more indicators according to a filter matrix, a bias vector, and a weight vector.
10: The system for processing data as either of paragraphs 8 or 9 describe, wherein the one or more processors are configured to execute the set of instructions to further perform: receiving a plurality of edge logs from one or more edge nodes, a plurality of external data feeds, or a combination thereof as the input data.
11: The system for processing data as any of paragraphs 8−10 describe, wherein the one or more processors are configured to execute the set of instructions to further perform generating, based on the input data, the plurality of wavelets by: generating one or more first wavelets from the input data; and deriving one or more second wavelets from the one or more first wavelets.
12: The system for processing data as any of paragraphs 8−11 describe, wherein the one or more processors are configured to execute the set of instructions to further perform: feeding the one or more indicators to a deep learning system for real-time processing.
13: The system for processing data as any of paragraphs 8−12 describe, wherein the one or more processors are configured to execute the set of instructions to further perform: merging a plurality of key-value databases storing the plurality of wavelets into a single file or a segmented file.
14: The system for processing data as any of paragraphs 8−13 describe, wherein the one or more processors are configured to execute the set of instructions to further perform: storing the key-value database into a memory in a data serialization format.
15: A non-transitory computer-readable medium storing one or more programs, the one or more programs comprising instructions which, when executed by one or more processors of a system, cause the system to perform operations comprising: receiving input data associated with a plurality of transactions; generating, based on the input data, a plurality of wavelets corresponding to the plurality of transactions; storing the plurality of wavelets and corresponding keys associated with the wavelets in a key-value database; and outputting, based on the plurality of wavelets, one or more indicators.
16: The non-transitory computer-readable medium as paragraph 15 describes, wherein the one or more programs comprising instructions which, when executed by the one or more processors of the system, cause the system to further perform operations comprising: converting the wavelets into the one or more indicators according to a filter matrix, a bias vector, and a weight vector.
17: The non-transitory computer-readable medium as either of paragraphs 15 or 16 describe, wherein the one or more programs comprising instructions which, when executed by the one or more processors of the system, cause the system to further perform operations comprising: receiving a plurality of edge logs from one or more edge nodes, a plurality of external data feeds, or a combination thereof as the input data.
18: The non-transitory computer-readable medium as any of paragraphs 15-17 describe, wherein the one or more programs comprising instructions which, when executed by the one or more processors of the system, cause the system to further perform generating, based on the input data, the plurality of wavelets by: generating one or more first wavelets from the input data; and deriving one or more second wavelets from the one or more first wavelets.
19: The non-transitory computer-readable medium as any of paragraphs 15-18 describe, wherein the one or more programs comprising instructions which, when executed by the one or more processors of the system, cause the system to further perform operations comprising: feeding the one or more indicators to a deep learning system for real-time processing.
20: The non-transitory computer-readable medium as any of paragraphs 15-19 describe, wherein the one or more programs comprising instructions which, when executed by the one or more processors of the system, cause the system to further perform operations comprising: merging a plurality of key-value databases storing the plurality of wavelets into a single file or a segmented file.
21: The non-transitory computer-readable medium as any of paragraphs 15-20 describe, wherein the one or more programs comprising instructions which, when executed by the one or more processors of the system, cause the system to further perform operations comprising: storing the key-value database into a memory in a data serialization format.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein.

What is claimed is:

1. A data processing method, comprising:
receiving input data associated with a plurality of transactions;
generating, based on the input data, a plurality of wavelets corresponding to the plurality of transactions;
storing the plurality of wavelets and corresponding keys associated with the wavelets in a key-value database; and
outputting, based on the plurality of wavelets, one or more indicators.

2. The data processing method of claim 1, further comprising:
converting the wavelets into the one or more indicators according to a filter matrix, a bias vector, and a weight vector.

3. The data processing method of claim 1, further comprising:
receiving a plurality of edge logs from one or more edge nodes, a plurality of external data feeds, or a combination thereof as the input data.

4. The data processing method of claim 1, wherein generating, based on the input data, the plurality of wavelets comprises:
generating one or more first wavelets from the input data; and
deriving one or more second wavelets from the one or more first wavelets.

5. The data processing method of claim 1, further comprising:
feeding the one or more indicators to a deep learning system for real-time processing.

6. The data processing method of claim 1, further comprising:
merging a plurality of key-value databases storing the plurality of wavelets into a single file or a segmented file.

7. The data processing method of claim 1, further comprising:
storing the key-value database into a memory in a data serialization format.

8. A system for processing data, comprising:
a memory device storing a set of instructions; and
one or more processors configured to execute the set of instructions to perform:
receiving input data associated with a plurality of transactions;
generating, based on the input data, a plurality of wavelets corresponding to the plurality of transactions;
storing the plurality of wavelets and corresponding keys associated with the wavelets in a key-value database; and
outputting, based on the plurality of wavelets, one or more indicators.

9. The system for processing data of claim 8, wherein the one or more processors are configured to execute the set of instructions to further perform:
converting the wavelets into the one or more indicators according to a filter matrix, a bias vector, and a weight vector.

10. The system for processing data of claim 8, wherein the one or more processors are configured to execute the set of instructions to further perform:
receiving a plurality of edge logs from one or more edge nodes, a plurality of external data feeds, or a combination thereof as the input data.

11. The system for processing data of claim 8, wherein the one or more processors are configured to execute the set of instructions to further perform generating, based on the input data, the plurality of wavelets by:
generating one or more first wavelets from the input data; and
deriving one or more second wavelets from the one or more first wavelets.

12. The system for processing data of claim 8, wherein the one or more processors are configured to execute the set of instructions to further perform:
feeding the one or more indicators to a deep learning system for real-time processing.

13. The system for processing data of claim 8, wherein the one or more processors are configured to execute the set of instructions to further perform:
merging a plurality of key-value databases storing the plurality of wavelets into a single file or a segmented file.

14. The system for processing data of claim 8, wherein the one or more processors are configured to execute the set of instructions to further perform:
storing the key-value database into a memory in a data serialization format.

15. A non-transitory computer-readable medium storing one or more programs, the one or more programs comprising instructions which, when executed by one or more processors of a system, cause the system to perform operations comprising:
receiving input data associated with a plurality of transactions;
generating, based on the input data, a plurality of wavelets corresponding to the plurality of transactions;
storing the plurality of wavelets and corresponding keys associated with the wavelets in a key-value database; and
outputting, based on the plurality of wavelets, one or more indicators.

16. The non-transitory computer-readable medium of claim 15, wherein the one or more programs comprising instructions which, when executed by the one or more processors of the system, cause the system to further perform operations comprising:
converting the wavelets into the one or more indicators according to a filter matrix, a bias vector, and a weight vector.

17. The non-transitory computer-readable medium of claim 15, wherein the one or more programs comprising instructions which, when executed by the one or more processors of the system, cause the system to further perform operations comprising:
receiving a plurality of edge logs from one or more edge nodes, a plurality of external data feeds, or a combination thereof as the input data.

18. The non-transitory computer-readable medium of claim 15, wherein the one or more programs comprising instructions which, when executed by the one or more processors of the system, cause the system to further perform generating, based on the input data, the plurality of wavelets by:
generating one or more first wavelets from the input data; and
deriving one or more second wavelets from the one or more first wavelets.

19. The non-transitory computer-readable medium of claim 15, wherein the one or more programs comprising instructions which, when executed by the one or more processors of the system, cause the system to further perform operations comprising:
feeding the one or more indicators to a deep learning system for real-time processing.

20. The non-transitory computer-readable medium of claim 15, wherein the one or more programs comprising instructions which, when executed by the one or more processors of the system, cause the system to further perform operations comprising:
merging a plurality of key-value databases storing the plurality of wavelets into a single file or a segmented file.

21. The non-transitory computer-readable medium of claim 15, wherein the one or more programs comprising instructions which, when executed by the one or more processors of the system, cause the system to further perform operations comprising:
storing the key-value database into a memory in a data serialization format.
